(19) United States
(12) Patent Application Publication
(10) Pub. No.: US 2013/0125651 A1
(43) Pub. Date: May 23, 2013

(54) FAIL SAFE TEST FOR A BANDWIDTH CHECK ON INERTIAL SENSING COMPONENTS

(71) Applicants: Greg Morningstar, Canton, MI (US); Mike Babala, Plymouth, MI (US)

(72) Inventors: Greg Morningstar, Canton, MI (US); Mike Babala, Plymouth, MI (US)

(73) Assignee: KELSEY-HAYES COMPANY, Livonia, MI (US)

(21) Appl. No.: 13/298,817

(22) Filed: Nov. 17, 2011

(51) Int. Cl. G01P 15/00

(52) U.S. Cl. 73/514.16

(57) ABSTRACT

The output amplitude of an inertial sensor output signal is compared to an upper and a lower limit to determine whether or not the bandwidth of the sensor is within specification.

### BACKGROUND OF THE INVENTION

This invention relates in general to inertial, or motion, sensors used in vehicle electronic safety control systems and in particular to a fail safe test bandwidth test for inertial sensor modules.

Electronic safety control systems for vehicles are becoming increasingly sophisticated. Such safety systems may include an Anti-Lock Brake System (ABS), a Traction Control (TC) System, a Vehicle Stability Control (VSC) System and airbag control units with rollover detection. The safety control system typically monitors vehicle motion parameters and is operable to selectively activate the vehicle wheel brakes and/or modify engine performance to avoid potential unwanted vehicle motions, such as, for example, a vehicle roll-over. The safety control system also may be operable to deploy airbags at an appropriate time.

Electronic safety control systems typically include a plurality of inertial sensors, such as accelerometers and angular rate sensors, that are utilized to sense vehicle motion. The signals generated by elements within the Electronic safety control systems sensors are typically modified by a signal conditioning circuit and then provided to a microprocessor in an Electronic Control Unit (ECU) of the electronic safety control system. The ECU microprocessor utilizes a stored algorithm to monitor the vehicle motion parameters, and, upon detecting a potential vehicle stability problem or crash/rollover condition, the microprocessor initiates corrective action by selectively activation the wheel brakes and/or deploying airbags.

The inertial sensors are typically packaged in a module with supporting signal conditioning circuitry, with the module containing one or more accelerometers and/or one or more angular rate sensors. Key to successful operation of the safety control system is proper functioning of the inertial sensors and signal conditioning circuitry. Accordingly, it is know to failsafe inertial sensor modules by applying a self test to the sensor module. Such self tests typically include applying an input signal to each one of the inertial sensors. The self test input signal is generated by the safety control system microprocessor and applied to a self test input that is provided on the motion sensor module. If the motion sensor is operating properly, a fixed offset will appear on the sensor output signal appearing at an output of the sensor module. If the microprocessor does not detect the offset after applying the self test activation signal, it is an indication of a sensor malfunction and the microprocessor will generate an error signal or code. However, during the self test activation, the self test signal may saturate the device, thus limiting the usefulness of the sensor during the self test. Additionally, the frequency of the self test technique may be limited by the bandwidth of the motion sensor module. Therefore, this type of self testing is typically done while the vehicle is standing still, such as upon initial start-up of the vehicle.

Some inertial sensor modules, such as the module 10 illustrated in FIG. 1, have a test status port 12 which is connected to a safety control system microprocessor (not shown). The test status port 12 changes state either during a self test or if an internal fault is detected. Also shown in FIG. 1 is a sensor module voltage supply port 14 that is connected to the vehicle power supply. An output port 16 at which the sensor output signal appears and a test activation port 18 are also connected to the safety control system microprocessor. The microprocessor is operative to apply a self test signal, as described above, to the test activation port 18 upon initial vehicle start-up. Finally, a ground port 20 is connected to the vehicle ground.

During a typical start-up self test, a supply voltage Vt is applied to the voltage supply port 14. In response, an output voltage builds up on the output port 16, reaching a steady state value. After the output port 16 reaches its steady state value, the test status port 12 goes high. A self test activation signal is then applied to the test activation port 18 by the safety control system microprocessor, which causes the test status port 12 to go low. In response to the test activation signal, the output voltage increases by an offset voltage. The offset voltage on the output voltage port 16 is compared to an acceptable offset voltage range by the microprocessor and, upon the offset voltage remaining below an acceptable threshold, the sensor is deemed as working satisfactorily. The test concludes with termination of the test activation signal, which causes the test activation port 18 to go low. If no problem has been detected with the sensor 10, the test status port 12 goes high while the output voltage decays to the original value.

Because the above described self test is typically only carried out at start up of the vehicle and not while the vehicle is in operation, the result does not consider the available output signal bandwidth of the inertial sensor. The inertial sensor bandwidth is important for the proper operation of vehicle electronic safety control systems, such as VSC. Changes in the sensor signal output bandwidth will change the behavior of VSC systems. While inertial sensor bandwidth is checked during manufacture, the bandwidth may drift with aging of the components or due to other component changes, such as failure of a component. Therefore, it is important to verify that the sensor signal output bandwidth is within specification in order to minimize unwanted phase and amplitude variation of the VSC system. Accordingly, it would be desirable to provide an output signal bandwidth self-test.

### SUMMARY OF THE INVENTION

This invention relates to a fail safe test bandwidth test for inertial sensor modules.

The present invention contemplates a test method that includes taking at least one sample of an inertial sensor output. The sensor output sample is compared to at least one limit and an error flag is set if the sensor output sample is either greater than an upper limit or less than a lower limit. The invention also contemplates comparing the sensor output sample to both upper and lower limits with the error flag being set if the sensor output sample is outside of a range set by the upper and lower limits where the upper and lower limits are a function of the sensor bandwidth.

Various objects and advantages of this invention will become apparent to those skilled in the art from the following detailed description of the preferred embodiment, when read in light of the accompanying drawings.

### BRIEF DESCRIPTION OF THE DRAWINGS

FIG. 1 is a block diagram of a typical inertial sensor module.

FIG. 2 illustrates a fail-safe sensor bandwidth test that is in accordance with the invention.

FIG. 3 is a flow chart for an algorithm for implementing the fail-safe sensor bandwidth test shown in FIG. 2.

FIG. 4 is a flow chart for an alternate embodiment of the algorithm for implementing the fail-safe sensor bandwidth test shown in FIG. 2.

### DETAILED DESCRIPTION OF THE PREFERRED EMBODIMENT

The output of an inertial sensor is set by an external bandwidth capacitor as well as internal sensor amplifiers. Additionally, the rate of rise of the sensor output signal is a function of the sensor bandwidth. However, as stated above, inertial sensor bandwidth may drift with aging of the components or due to other component changes, such as failure of a component. For example, an open bandwidth capacitor would have a signal that rises too fast and would be outside of the specified bandwidth for the sensor. Therefore, the present invention contemplates comparing amplitudes of samples of an inertial sensor output signal to acceptable limits based upon rates of change for the samples. Because the rates of change for the samples are a function of the sensor bandwidth, a sample that is outside of the limits would be indicative of sensor bandwidth being out of specification. Also, by knowing the sensor specification bandwidth and tolerances of supporting circuitry, it is possible to develop the limits as a function of the acceptable rise time of the output signal for maximum and minimum sensor bandwidth frequencies.

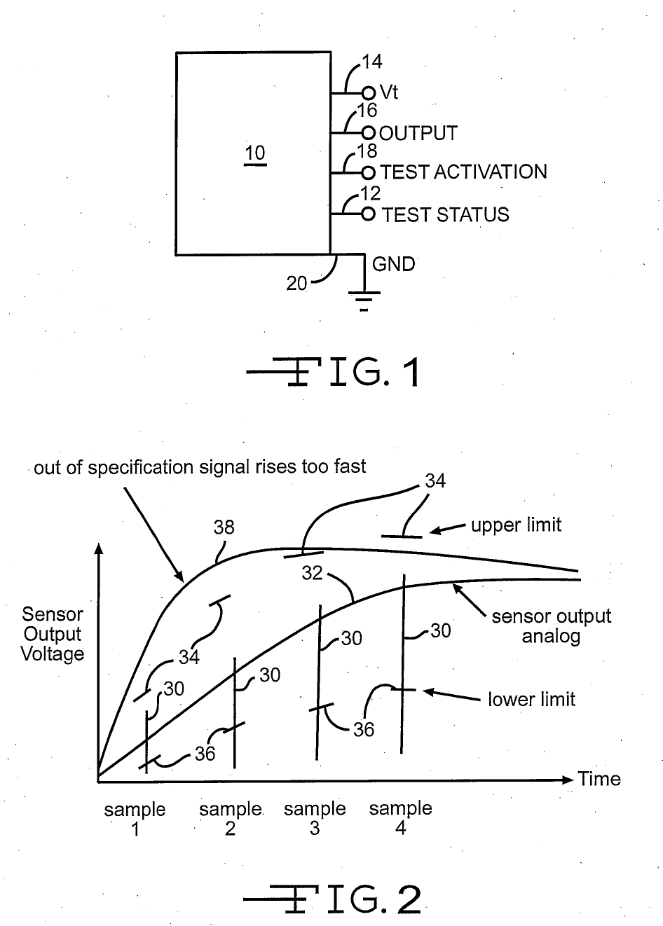

Referring again to the drawings, there is illustrated in FIG. 2 the operation of a fail-safe sensor bandwidth test that is in accordance with the invention. In FIG. 2, the output voltage of the sensor being tested is shown as a function of time. The sensor output voltage consists of a plurality of sequential samples 30, four of which are shown in FIG. 2, that have varying amplitudes. The output samples 30 also may be represented by an analog sensor output voltage, which is shown by the line labeled 32. The amplitudes of the analog voltage sample 32 are compared to upper and lower limits 34 and 36, respectively that are a function of the specification bandwidth for the sensor. The present invention contemplates that either the actual amplitudes of the sensor output sequential samples 30 or the analog output voltage 32 may be compared to the limits 34 and 36. An analog sensor output voltage labeled 38 that is above the upper limits 34 and would result from an out of specification bandwidth is also shown in FIG. 2. Not shown is an analog output voltage that is below the lower limits 36. If the output signal amplitude is outside of a range defined by the upper and lower limits, an error flag is set, as described below.

The present invention contemplates that the upper and lower limits 34 and 36 are derived from the circuit components with the following relationship:

V_{c}(t)=V(1−e^{-t/RC}), where:
V_{c}(t) is the expected sensor output voltage,
t is the time that the output signal is sampled,
V is the steady state sensor output voltage, and
RC is the time constant of based upon the filter circuit.

The limits may be calculated as being a predetermined percentage above or below the expected output value, as shown by the following formulas:

T_{HN}=(100+selected percentage)V_{C}(t_{N}), and

T_{LN}=(100−selected percentage)V_{C}(t_{N}), where
T_{HN} is the upper limit at the time at which sample N is taken;
T_{LN} is the lower limit at the time at which sample N is taken; and
t_{N} is the time at which sample N is taken.
   Thus, if a 10 percent tolerance is desired, the value for the upper limit T_{HN} is 1.1*V_{C}(t_{N}) while the value for the lower limit T_{LN} is 0.9*V_{C}(t_{N}).

It is to be understood that the percentage utilized above is meant is to be illustrative and that other percentages may be used to calculate the upper and lower limits T_{HN} and T_{LN}. Furthermore, different values for the percentage may be utilized, for example, the upper limit T_{HN} may be selected to be 10 percent greater than the expected sensor output voltage at the selected sampling time while the lower limit T_{LN} may be selected to five percent less than the sensor output voltage at the same sampling time. It is also contemplated that a predetermined voltage may be added and subtracted from the expected voltage to establish the limits, as shown in the following formulas:

T_{HN}=V_{C}(t_{N})+0.1, and

T_{LN}=V_{C}(t_{N})−0.1.

In the above example, one tenth of a volt is added to the expected sensor output voltage at the selected sampling time to obtain the upper limit while one tenth of a volt is subtracted from the sensor output voltage at the same sampling time to obtain the lower limit.

It will be appreciated that the invention also may be practiced with different amounts being added and subtracted to the expected output voltage. For both the percentage and the addition and subtraction methods, either the lower or the upper limit may be equal to the expected voltage at the sampling time (not shown). Both the upper and lower limits may also be set equal to the expected voltage at the sampling time (not shown), if zero tolerance is to be allowed for the sensor output signal. It must be understood that the above methods of calculating the upper and lower limits are meant to exemplary and other methods than specific ones shown above may be used to calculate the limits T_{HN} and T_{LN}.

While the present invention has been illustrated and described above as utilizing analog voltages as the senor output signal, it will be appreciated that the invention also may be practiced with any output format such as, for example, voltage expressed in a digital format, engineering units or digital counts. “Engineering units” refers to circumstances where a host microprocessor converts the sensor output to a digital signal that may be transmitted over a Controller Area Network (CAN) while “counts” refers to a digital sensor communicating over a bus, such as, for example, a Serial Peripheral Interface (SPI) (not shown). Furthermore, the application of the invention is not intended to be limited to sensors utilized with safety control systems. Indeed, it is contemplated that the present invention may be applied to any and all Inertial Measurement Units (IMUs) which also may be utilized as stand alone sensors that may feed output signals into a CAN bus or other data transfer system. Regarding the possible alternate sensor output signal formats, the invention further contemplates that the upper and lower limits would be adapted to the same format to allow comparison to the sampled output signal (not shown).

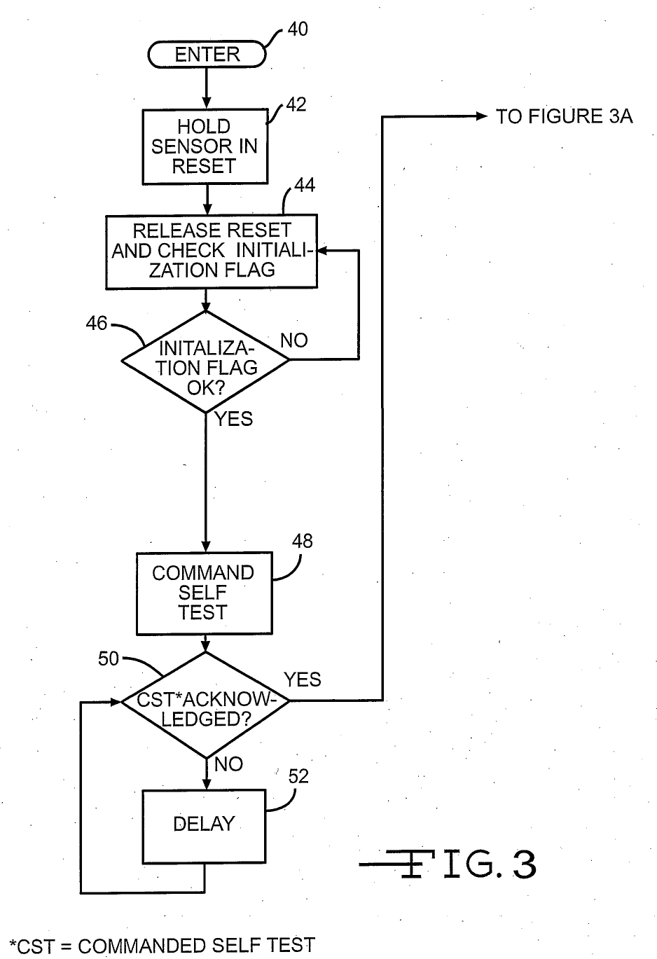

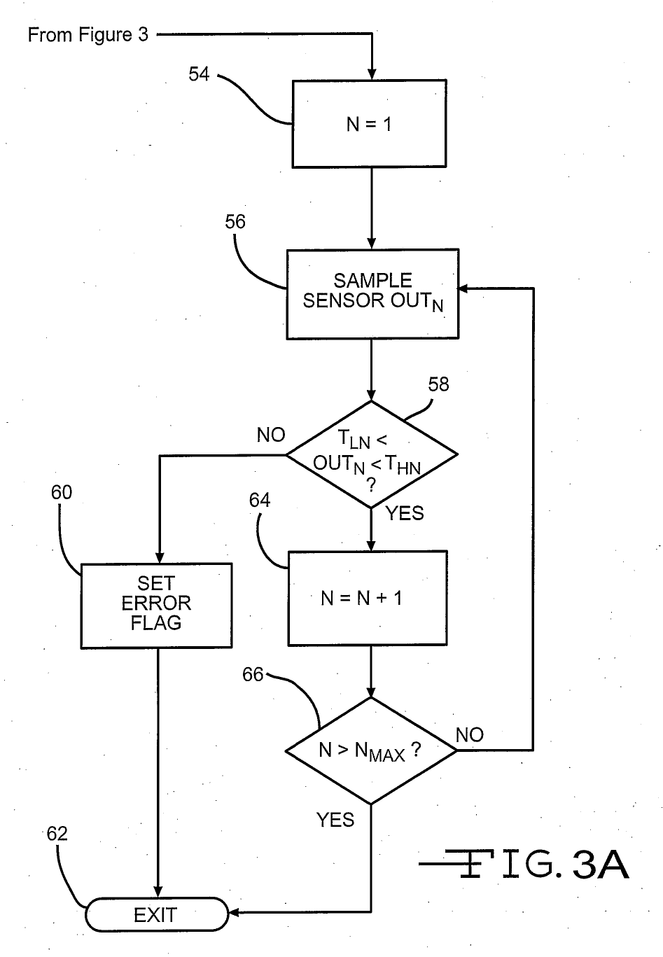

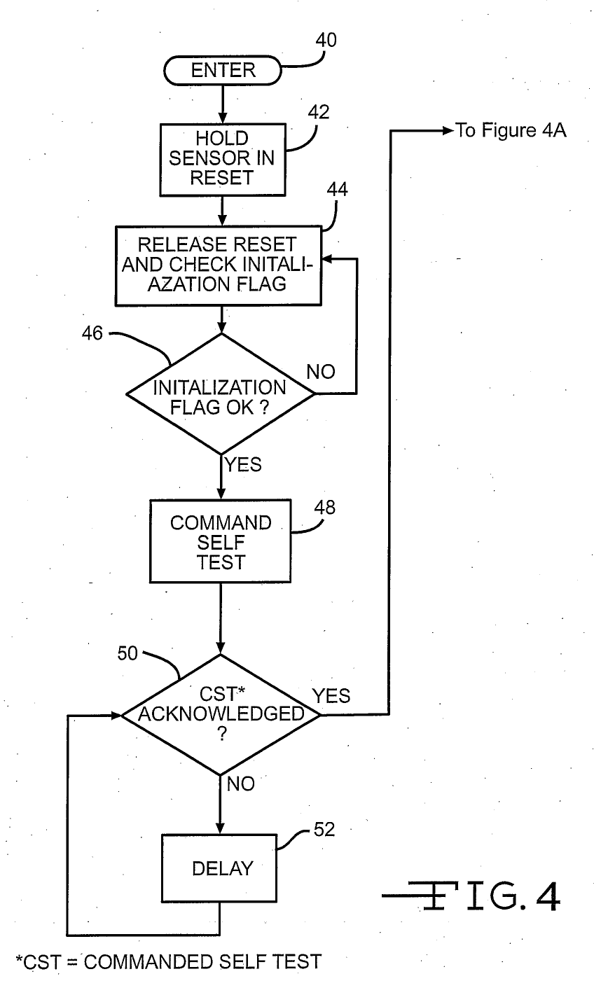

The present invention also contemplates that the fail-safe sensor bandwidth test will be included in the control algorithm stored in the safety control system Electronic Control Unit (ECU) (not shown). The safety control system microprocessor controls the operation of the safety control system microprocessor that is responsive to sensor signals to initiate corrective action by selectively activating the vehicle wheel brakes and/or deploying airbags. A flow chart for the bandwidth test is shown in FIG. 3. The algorithm is entered through block 40 and proceeds to functional block 42 where the sensor being tested is placed into and held in a reset condition pending the determination that the ECU microprocessor is ready to measure the sensor output. The algorithm then advances to functional block 44 where the sensor reset condition is released and the sensor test status port 12 output is read. From functional block 44 the algorithm proceeds to decision block 46 where the test status port output is checked.

If the output at the test status port 12 is high in decision block 46, the sensor reset has been released and the sensor 10 is ready for testing; but if the status port output is low, the sensor reset has not been released and the sensor is not ready for testing. If the test status port 12 is low, the algorithm transfers back to functional block 44 where the sensor reset condition is again released and the sensor output test status port 12 status is again checked. If the test status port 12 is high, the algorithm transfers to functional block 48.

In functional block 48, the bandwidth self test is commanded. The algorithm then continues to decision block 50 where the sensor test status port 12 is again checked. If the test status port is still high, the self-test command has not been acknowledged and the algorithm transfers to functional block 52 where a delay is introduced to allow the test command to be acknowledged. The algorithm then transfers back to decision block 50 where the sensor test status port 12 is rechecked. If, in decision block 50, it is determined that the test status port is now low, the self-test command has been acknowledged and the algorithm transfers to functional block 54.

In functional block 54, an index N that represents the number of sensor output samples to be checked during the test is set to unity. The algorithm then advances to function block 56 where the sensor output voltage amplitude OUT_{N} is measured. The algorithm then continues to decision block 58 where the sensor output voltage amplitude is compared to predetermined upper and lower limits T_{HN} and T_{LN}, respectively, that are a function of the bandwidth and the sensor output index N. Thus, the upper and lower limits T_{HN} and T_{LN}, respectively, are also a function of time and are derived as a function of the sensor output formula presented above. Solution of the formula provides an expected value and then the upper and lower limits may be taken T_{HN} and T_{LN} calculated for a specific time t from the expected sensor output value at the time t.

If the sensor output voltage amplitude is outside of the range defined by the predetermined upper and lower limits T_{LN} and T_{HN}, the sensor bandwidth is out of specification and the algorithm transfers to functional block 60 where an error flag is set. Setting the error flag will cause an error signal, visual and/or audio, to be activated to warn the vehicle driver. Additionally, setting the error flag also may result in the system that utilizes the sensor output being taken out of service. Once the error flag is set, the test is completed and the algorithm exits through block 62.

If, in decision block 58, the sensor output voltage amplitude is within the range defined by the predetermined upper and lower limits T_{LN} and T_{HN}, the sensor bandwidth is within specification and the algorithm transfers to functional block 64 where the sensor output index N is increased by one. The algorithm then advances to decision block 66 where the current sensor output index N is compared to a maximum sample threshold N_{MAX}. The maximum sample threshold N_{MAX} is equal to the desired number of senor output samples to be utilized in the test. In the preferred embodiment, four samples are used; however, more or less samples than four also may be used. If the current sensor output index N is greater than the maximum sample threshold N_{MAX}, the desired number of senor output samples have been utilized and the algorithm exits through block 62 without setting an error flag. If, on the other hand, the current sensor output index N is less than or equal the maximum sample threshold N_{MAX}, the desired number of senor output samples have not been examined and the algorithm transfers back to functional block 56 where the next sensor output voltage amplitude OUT_{N+1} is measured. The algorithm than continues as described above.

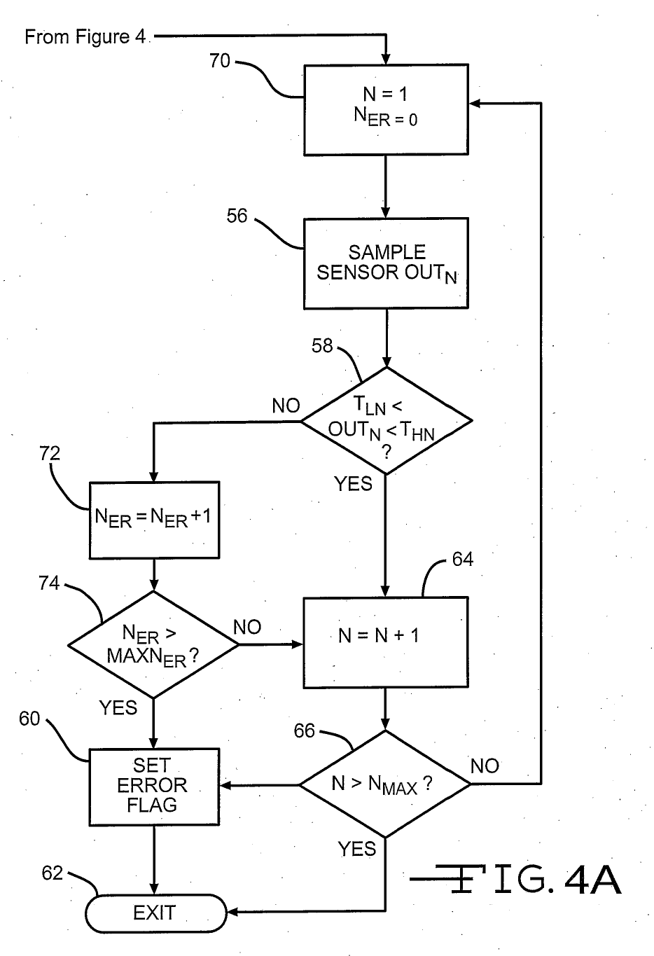

The algorithm shown in FIG. 3 generates an error signal if one iteration of the algorithm determines that the sensor output is out of the acceptable range. In order to avoid false error signals, an alternate embodiment of the algorithm is shown in FIG. 4 where an error must be detected for a predetermined number, NI, of samples before an error signal is generated. Blocks shown in FIG. 4 that are similar to blocks shown in FIG. 3 have the same numerical identifiers. As shown in FIG. 4, blocks 40 through 52 are the same as shown in FIG. 3 and the alternate embodiment operates is the same manner as described above through block 52. However, upon determining in decision block 50 that the test status port is now acknowledged, the algorithm transfers to functional block 70. In functional block 70, the index N that represents the number of sensor output samples to be checked during the test is set to unity, as described above, but a second index to count the number of errors during the test, N_{ER}, is set to zero in functional block 70. The algorithm then proceeds as described above until decision block 58 is reached.

As shown in FIG. 4, if the sensor output voltage amplitude is outside of the range defined by the predetermined upper and lower limits T_{EN} and T_{HN}, the sensor bandwidth is out of specification and the algorithm transfers to functional block 72 where the number of errors N_{ER} is indexed by one. The algorithm then continues to decision block 74 where the current number of errors is compared to a maximum allowable number of errors, MAXN_{ER}. If the number of errors N_{ER} is greater than the maximum allowable number of errors, MAXN_{ER}, the algorithm transfers to functional block 60 where the error flag is set and the algorithm then exits through block 62.

If, in decision block 74, If the number of errors N_{ER} is less than the maximum allowable number of errors, MAXN_{ER}, the algorithm transfers to function block 64 and continues as described above. Similarly, returning to decision block 58, if the sensor output voltage amplitude is within the range defined by the predetermined upper and lower limits T_{EN} and T_{HN}, the sensor bandwidth is within specification and the algorithm transfers to functional block 64 and continues as described above.

While the algorithm illustrated in FIG. 4 sets the error flag only if a predetermined number of errors are detected during a single test, it will be appreciated that the invention also may be practiced with the error flag being set only after a predetermined number of consecutive tests are failed (not shown). The individual consecutive tests may be considered a failure if either one error is detected during the individual test or if a predetermined number of errors are detected during the individual test. When a predetermined number of errors being detected during the test is the criteria for setting the error flag, the errors may either occur consecutively or non-consecutively (not shown).

Because the present invention utilizes the sensor output signal, it is contemplated that the test may be run while the sensor is in service. Thus, the test is not limited to only times when the vehicle is being started. Additionally, the test may be run continuously, being restarted once the number of the number of sensor output samples to be checked N is exceeded, or on a periodic basis (not shown). With regard to periodic running to the test, the test may be run either with a predetermined time period between test and/or at random time intervals (not shown).

It will be appreciated that the flow charts shown in FIGS. 3 and 4 are meant to be exemplary of the test algorithm and that the invention also may be practiced with algorithms having structures that differ from the flow charts shown in FIGS. 3 and 4.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

What is claimed is:

1. A method for testing the bandwidth of an inertial sensor comprising the steps of:
(a) taking at least one sample of an inertial sensor output;
(b) comparing the sensor output sample taken in step (a) to at least one limit;
(c) setting an error flag if the sensor output sample taken in step (a) is one of greater than an upper limit and less than a lower limit.

2. The method according to claim 1 wherein step (b) includes comparing the sensor output sample taken in step (a) to an upper and a lower limit and further wherein step (c) includes setting the error flag if the sensor output sample is one of greater than the upper limit and less than the lower limit.

3. The method according to claim 2 wherein the upper and lower limits are a function of the inertial sensor bandwidth.

4. The method according to claim 3 wherein the upper and lower limits are also a function of sampling time.

5. The method according to claim 4 wherein the amplitude of the sensor output is sampled during step (a).

6. The method according to claim 5 wherein the sensor output sample taken in step (a) is a voltage.

7. The method of claim 6 where the upper and lower limits are determined using the relationship:
V_{c}(t)=V(1−e^{-t/RC}), where:
V_{c}(t) is the expected sensor output voltage,
t is the time that the output signal is sampled,
V is the steady state sensor output voltage, and
RC is the time constant of based upon the filter circuit.

8. The method according to claim 4 wherein steps (a) and (b) are repeated for a first predetermined number of times and the error flag in step (c) is set only after a second predetermined number of instances during which the amplitudes of the samples taken in step (a) are one of greater than the upper limit and less than the lower limit.

9. The method according to claim 8 wherein the second predetermined number of instances during which the amplitudes of the samples taken in step (a) are one of greater than the upper limit and less than the lower limit occur sequentially.

10. The method according to claim 8 wherein the first predetermined number is equal to the second predetermined number.

11. The method according to claim 4 wherein the inertial sensor is one of an acceleration sensor and a yaw sensor.

12. The method according to claim 2 wherein the upper and lower limits are a function of the output sample rise time.

13. The method according to claim 8 further including a step of generating an alarm signal upon the error flag being set.

14. The method according to claim 8 further including a step of disabling a system associated with the sensor being tested.
